(19) United States
(12) Patent Application Publication
(10) Pub. No.: US 2021/0056137 A1
(43) Pub. Date: Feb. 25, 2021

(54) SYSTEMS AND METHODS FOR PROVIDING DATA FROM PLURALITY OF SOURCES

(71) Applicant: JETSYNTHESYS PVT LTD, Pune, Maharashtra (IN)

(72) Inventors: Rajan Ramesh Navani, Pune, Maharashtra (IN); Parimit Umedsinh Parmar, Pune, Maharashtra (IN); Nitin Kumar Gupta, Pune, Maharashtra (IN)

(73) Assignee: JETSYNTHESYS PVT LTD, Pune, Maharashtra (IN)

(21) Appl. No.: 16/334,461

(22) PCT Filed: Sep. 19, 2017
(86) PCT No.: PCT/IN2017/050409

§ 371 Date: Mar. 19, 2019

(30) Foreign Application Priority Data
Sep. 19, 2016 (IN) 201621031881

(51) Int. Cl. G06F 16/906; G06F 16/9035; G06F 16/953; G06F 16/25; H04L 29/06

(52) U.S. Cl. CPC G06F 16/906; G06F 16/9035; H04L 63/0815; G06F 16/256; G06F 16/953

(57) ABSTRACT

The present invention provides concepts related to a computing platform for integrating a plurality of data collected from a plurality of sources. The present invention comprises of authentication of one or more users to provide an access to a computing platform. Further, one or more jobs are scheduled on a web server to fetch the plurality of data from the plurality of sources. The web server is further polled for fetching the plurality of data and this fetched plurality of data is aggregated based on one or more user defined rules. Furthermore, the aggregated data is stored in a content repository and further analysed based on the user defined rules. The analysed data is then stored in a database. Further, the data is streamed based on one or more request received from the web server and rendering the same to the users.

### TECHNICAL FIELD

The present invention relates generally to collecting and integrating a plurality of data from plurality of data sources, and, particularly but not exclusively, to an integration platform to collect plurality of social media content from plurality of social media platform.

### BACKGROUND

Over the last several years within the field of computing, a trend is on the rise of social networking platform, wherein users of the platform may establish—a kind of—associations representing different kind of relationship with other users. Users of the social media platform may share some data of interest with every connected user or some other associated users based on their associations on the social media platform. In the present context, the users of the social media may be defined in two ways, firstly a content generator such as famous personality or celebrity and secondly a content receiver such as an end user of the social media or followers of the celebrity. Further, in this present context, a set of specific users such as a famous personality, may establish a social profile comprising data that provides various aspects of the user to the associated users or their followers. Such users may choose to share certain social data with the connected users or their followers for example, public or personal information, image and the like. In this manner, the users may share social data items over the social network with their followers.

Conventionally, social media users like famous personalities primarily sign up for social networking services to make their online social presence felt among their followers and further it also leads to market their products, brands, events and the like. Whether the user posts on a specific social platform, for example, Facebook or tweets on Twitter, or simply appears in any other social network, followers of the user almost have instant connection with the user. Moreover, the multitude of social media platforms and their critical nature presents a number of issues for the celebrities to connect with the followers.

Presently, there are few social media platforms which provides very limited data related to a celebrity. Let's say an end user or the follower of the celebrity wants to know where a particular event is going to take place next, or wants to buy some of merchandise of the celebrity, or wants to interact with the celebrity, the user has to leave the originating application (App), open up their browser, and search through endless possibilities to find this additional information. In doing so, these Apps may fall short in grabbing the important information. Also, due to the number of individual social media platforms, the end users often have to create and manage plurality of accounts, resulting in poor ease of use. Thus, one of the issues associated with harnessing social media platform for the purpose of engagement of the celebrity with their followers, is the ease of use.

Further, the conventional technologies provide an exemplary method that aggregates and publishes the content of users or organizations across a wide variety of social networking platforms. However, the conventional methods and systems provide a complex functionality to do a search, wherein a user has to enter the keywords to search/filter terms used by the search. Further, the system enables the keyword search across all the different social network platforms and the predefined publicly available data which is relevant and then the system aggregates the search results. Such conventional systems and methods are time consuming and expensive.

Furthermore, many users find desired features missing from their mobile experience. These and other loopholes in social media applications are significant problem for the social media users and their followers. Another issue related with an end user or the follower is some they do not have an account on a particular social media platform so they are incapable to connect with the famous personalities. Thus, there is a requirement of a seamless access to mainstream social media network for everyone.

Hence, there is a need of an invention which solves the above defined problems and provide unified access to the social media data collected from various social media platform.

### SUMMARY

This summary is provided to introduce concepts related to a computing platform for integrating a plurality of data collected from a plurality of sources. This summary is neither intended to identify essential features of the present disclosure nor is it intended for use in determining or limiting the scope of the present disclosure.

For example, various embodiments herein may include one or more of systems, and methods for integrating a plurality of data collected from a plurality of sources. In one of the embodiments, the method comprises of authenticating one or more users to provide an access to a computing platform. Further, one or more jobs are scheduled on a web server to fetch the plurality of data from the plurality of sources. The web server is polled for fetching the plurality of data and this fetched plurality of data is aggregated based on one or more user defined rules. Additionally, the aggregated data is stored in a content repository and further analysed based on the user defined rules. The analysed data is further stored in a database. Further, streaming the data based on one or more request received from the web server and rendering the same to the users.

In another embodiment, the system is configured to act as a one stop platform where a plurality of data retrieved from a plurality of sources are aggregated based on user defined rules. The system includes an authentication module that is coupled with the processor and it is configured to authenticate one or more users to provide an access to a computing platform. Further, the system includes an aggregator module which is configured to schedule one or more jobs on a web server to fetch the plurality of data from the plurality of sources. The aggregator module is further configured to poll the web server to fetch the plurality of data and aggregate the fetched plurality of data based on one or more user defined rules. The system further includes a storage module which is configured to store the aggregated data to a content repository. Further, a classification module is configured to analyse the aggregated data based on the user defined rules and to store the analysed data in a database. The classification module is further configured to stream the data based on the request received from the web server. Additionally, a display module is configured to render said one or more requested data to the users.

### BRIEF DESCRIPTION OF ACCOMPANYING DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1 illustrates an exemplary block diagram depicting a computer implemented system for integrating a plurality of data collected from a plurality of sources, according to an exemplary implementation of the present disclosure.

FIG. 2 illustrates a flowchart of a method for providing a plurality of data from a plurality of sources in a computing environment, according to an exemplary implementation of the present disclosure.

FIG. 3 illustrates an architecture of the computing platform, according to an exemplary implementation of the present disclosure.

FIG. 4A illustrates an exemplary Single-Sign-On (SSO) facility of the computing platform, according to an exemplary implementation of the present disclosure.

FIG. 4B illustrates an exemplary aggregated data from plurality of sources on a single platform, according to an exemplary implementation of the present disclosure.

FIG. 4C illustrates an exemplary implementation of e-commerce facility integrated on the computing platform, according to an exemplary implementation of the present disclosure.

FIG. 4D illustrates an exemplary implementation of event calendar facility integrated on the computing platform, according to an exemplary implementation of the present disclosure.

FIG. 4E illustrates an exemplary implementation of instant messaging service (chat) integrated on the computing platform, according to an exemplary implementation of the present disclosure.

FIG. 5 illustrates an exemplary implementation of reverse posting of the content on the computing platform, according to an exemplary implementation of the present disclosure.

It should be appreciated by those skilled in the art that any block diagrams herein represent conceptual views of illustrative systems embodying the principles of the present disclosure. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

The various embodiments of the present disclosure provide a system and a method for integrating a plurality of data collected from a plurality of sources.

In the following description, for purpose of explanation, specific details are set forth in order to provide an understanding of the present disclosure. It will be apparent, however, to one skilled in the art that the present disclosure may be practiced without these details. One skilled in the art will recognize that embodiments of the present disclosure, some of which are described below, may be incorporated into a number of systems.

However, the systems and methods are not limited to the specific embodiments described herein. Further, structures and devices shown in the figures are illustrative of exemplary embodiments of the present disclosure and are meant to avoid obscuring of the present disclosure.

Furthermore, connections between components and/or modules within the figures are not intended to be limited to direct connections. Rather, these components and modules may be modified, re-formatted or otherwise changed by intermediary components and modules.

References in the present disclosure to “one embodiment” or “an embodiment” mean that a particular feature, structure, characteristic, or function described in connection with the embodiment is included in at least one embodiment of the invention. The appearances of the phrase “in one embodiment” in various places in the specification are not necessarily all referring to the same embodiment.

The present disclosure provides a computer implemented system and method for integrating a plurality of data collected from a plurality of sources, and the system and method involving at least one database management system.

In one implementation, the method comprises of authenticating one or more users to provide an access to a computing platform. Further, one or more jobs are scheduled on a web server to fetch the plurality of data from the plurality of sources. The web server is polled for fetching the plurality of data and this fetched plurality of data is aggregated based on one or more user defined rules. Additionally, the aggregated data is stored in a content repository and further analysed based on the user defined rules. The analysed data is further stored in a database. Further, streaming the data based on one or more request received from the web server and rendering the same to the users.

In another implementation, the system is configured to act as a one stop platform where a plurality of data retrieved from a plurality of sources are aggregated based on user defined rules. The system includes an authentication module that is coupled with the processor and it is configured to authenticate one or more users to provide an access to a computing platform. Further, the system includes an aggregator module which is configured to schedule one or more jobs on a web server to fetch the plurality of data from the plurality of sources. The aggregator module is further configured to poll the web server to fetch the plurality of data and aggregate the fetched plurality of data based on one or more user defined rules. The system further includes a storage module which is configured to store the aggregated data to a content repository. Further, a classification module is configured to analyse the aggregated data based on the user defined rules and to store the analysed data in a database. The classification module is further configured to stream the data based on the request received from the web server. Additionally, a display module is configured to render said one or more requested data to the users.

In another implementation, the system provides a facility of a single sign-on (SSO) wherein the user is connected to the platform every time using one single or federated identity. This identity may either be a social identity or a one-time password (OTP) generated on the registered mobile device of the user. Upon successful authentication, the user is connected with one consolidated platform where social media data across various social media platform such as Facebook, Twitter, YouTube etc., are presented in a consolidated manner.

In another implementation, the system is linked with an auto scheduler such as Cron task to fetch social media content at user defined or system defined interval of time from a plurality of social media platform. The scheduling task is defined in such a way every time before fetching the social media content from the various sources, the scheduler performs the crisscross operation to identify last fetched content information from the various sources. Thus, the scheduler efficiently fetches the latest content which was not fetched or available earlier.

According to the present implementation, the system is configured to perform sorting or classification operation on the content stored in the repository. Based on the timestamp information, data type and other user/system defined parameters, the platform performs the sorting operation on the content. Further, the sorted content is further stored in the desired location in the database. To this end, an analysis operation is also performed to generate various statistics from the content stored in the database. Furthermore, the stored content may be streamed to the user based on the request received from the web server. In response to the request, the content is rendered to the user.

In another implementation, for a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes and programs can be stored in a memory and executed by a processor.

It should be noted that the description merely illustrates the principles of the present disclosure. It will thus be appreciated that those skilled in the art will be able to devise various arrangements that, although not explicitly described herein, embody the principles of the present disclosure. Furthermore, all examples recited herein are principally intended expressly to be only for explanatory purposes to help the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

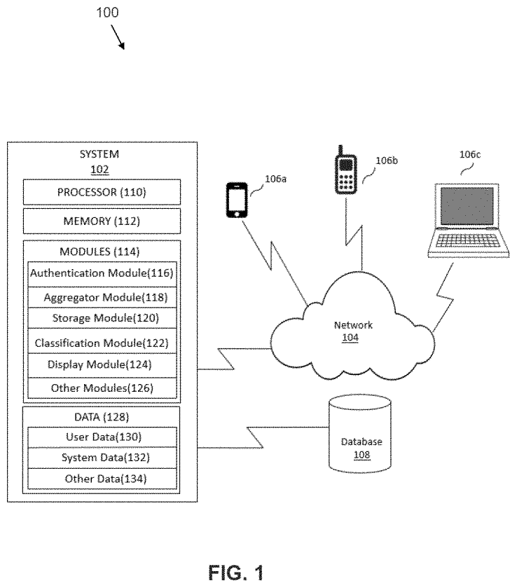

FIG. 1 illustrates an exemplary block diagram depicting a computer implemented system 100 for integrating a plurality of data collected from a plurality of sources, according to an exemplary implementation of the present disclosure. The computer implemented system 100 includes a system 102, a plurality of user devices 106 (106a, 106b, 106c), at least one database management system or a relational database 108, and a network 104.

The network 104 interconnects the user devices 106, and the database 108 with the system 102. The network 104 includes wired and wireless networks. Examples of the wired networks include, but are not limited to, a Wide Area Network (WAN) or a Local Area Network (LAN), a client-server network, a peer-to-peer network, and so forth. Examples of the wireless networks include, but are not limited to, Wi-Fi, a Global System for Mobile communications (GSM) network, and a General Packet Radio Service (GPRS) network, an enhanced data GSM environment (EDGE) network, 802.5 communication networks, Code Division Multiple Access (CDMA) networks, or Bluetooth networks. In an example, the network 104 may be a combination of one or more wired and/or wireless networks.

In the present implementation, the database 108 may be implemented as, but not limited to, enterprise database, remote database, local database, and the like. The database 108 may be located within the vicinity of the system 102 or may be located at different geographic locations as compared to that of the system 102. Further, the database 108 may themselves be located either within the vicinity of each other, or may be located at different geographic locations. Furthermore, the database 108 may be implemented inside the system 102 and the database 108 may be implemented as a single database.

In the present implementation, the system 102 includes one or more processor(s) 110. The processor 110 may be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in a memory 112.

The memory 112 may be coupled to the processor 110. The memory 112 can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the system 102 includes modules 114. The module 114 includes an authentication module 116, an aggregator module 118, a storage module 120, a classification module 122, a display module 124 and other modules(s) 126. The authentication module 116 is configured to authenticate one or more users to provide an access to a computing platform. The aggregator module 118 is configured to schedule one or more jobs on a web server to fetch the plurality of data from the plurality of sources. The aggregator module 118 is configured to poll said web server to fetch the plurality of data. Further, the aggregator module 118 is configured to aggregate fetched plurality of data such as social media content from a plurality of sources based on one or more user defined rules. Further, the storage module 120 is configured to store the aggregated data to a content repository Further, the classification module 122 is configured to analyse the aggregated data based on the system defined or user defined rule. The analysed contents are further stored as per their categories in the database 108. The classification module 122 is also configured to stream the data based on the request received from the web server. Further, the display module 124 is configured to render said one or more requested data to the users. The modules 114 also include the other modules 126. The other modules 126 is configured to provide any kind of operation which may be beyond the scope of the authentication module 116, aggregator module 118, storage module 120, classification module 122 and display module 124. In this context, the other modules 126 include every other task which are not configured for the authentication module 116, aggregator module 118, storage module 120, classification module 122 and display module 124.

In the present implementation, the data 128 may include various data pertaining to the operation of the processor 110, and other data 134. The data 128, amongst other things, may serve as a repository for storing data that is processed, received, or generated as a result of the execution of one or more modules in the other module(s) 126. Although the data 128 is shown internal to the system 102, it may be understood that the data 128 can reside in an external repository or the database 108, which may be coupled to the system 102. Further, the data 128 broadly includes a user data 130 and a system data 132. The user data 130 includes all the data pertaining to the user such as a user account details, user profile and the like. The system data 132 includes all other data except the user data 130. The user data 130 and the system data 132, both may be stored in the database 108.

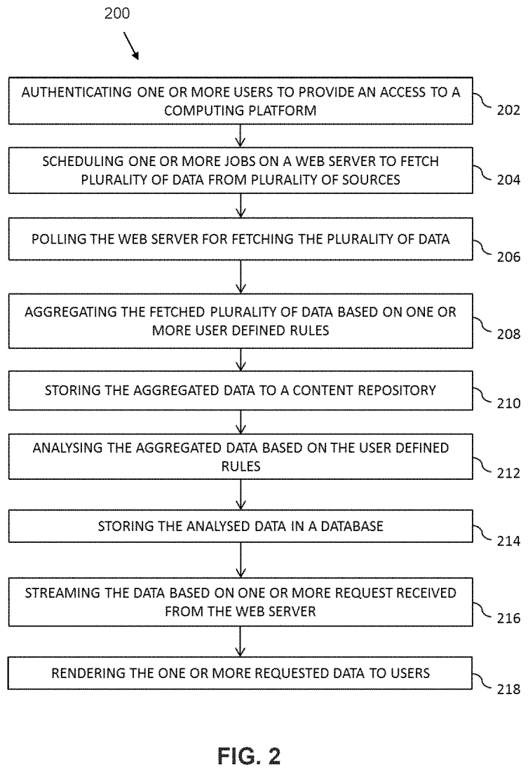

Referring now to FIG. 2, a flowchart 200 of a method for providing a plurality of data from a plurality of sources in a computing environment, according to an exemplary implementation of the present disclosure. The flowchart 200 of FIG. 2 is explained below with reference to FIG. 1 as described above.

At step 202, authenticating one or more users to provide an access to a computing platform.

At step 204, scheduling one or more jobs on a web server to fetch plurality of data from plurality of sources.

At step 206, polling the web server for fetching the plurality of data.

At step 208, aggregating the fetched plurality of data based on one or more user defined rules.

At step 210, storing the aggregated data to a content repository.

At step 212, analysing the aggregated data based on the user defined rules.

At step 214, storing the analysed data in a database.

At step 216, streaming the data based on one or more request received from the web server.

At step 218, rendering the one or more requested data to users.

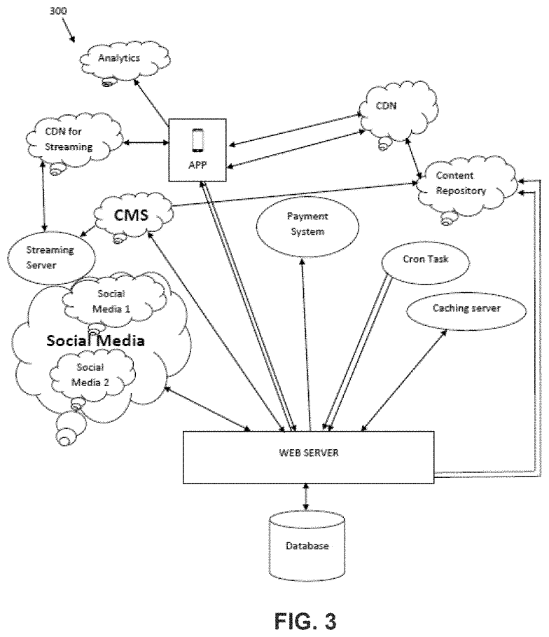

FIG. 3 illustrates an architecture of the computing platform, according to an exemplary implementation of the present disclosure. In the present architecture, at the starting step, the user has to enter user id and password for the authentication of the user profile. The information provided is compared to those on record in a database of authorized user's information present in an authentication module 116 of the platform. If the information matches, the authentication process is completed and in turn user is granted authorization for the access of the platform. Upon receiving the access, the web server requests the CMS, i.e. Content Management System to fetch the required information contents such as a video file, audio file, image file, etc. the CMS responds to the request of the web server by providing it with the content information. The content information received by the web server is then sent to the streaming server, where the information is stored. Upon the content information being stored in the streaming server, some of it is also stored in the content repository, which may be a database of digital content.

Further, in the present architecture, there is an independent task, i.e. the Cron task which initiates the process to fetch data from various social media platform and CMS, wherein it requests the web server to update the social feed and the content chunk. To this end, the cron task is a time-based job scheduler that schedules the tasks to run on the server. In the present context, it performs the fetching of the recent content such as most recent tweets or posts or any related information to be cached in a text file. Further, the web server connects to various social media sites and fetches the latest feeds and it also fetches content information from the CMS provided by the user.

The web server then categorizes the received feed and the content information as per timestamp information, creates json chunk and stores it in the content repository. In the present context, the content repository is a database of the digital content. The content repository then accelerates the categorized contents to the respective Content Delivery Network (CDN), which is a globally distributed network, to render the content to the end-users with high availability and high performance. Further, the platform interacts with the web server to get the required information pertaining to the content. After receiving the content information, it sends that information for analytics purpose. During analytics process, the analyzer classifies the data obtained from the server into predefined categories. To this end, the platform requests the content delivery network for streaming the data received from the content repository. If any information or data is not available with the content repository, then the CDN fetches the required content from the streaming server.

Further, the platform requests the content delivery network to provide with the information related to the social feed and the Image/Video chunk to which the CDN responds back to the platform by providing with the required data for display and download.

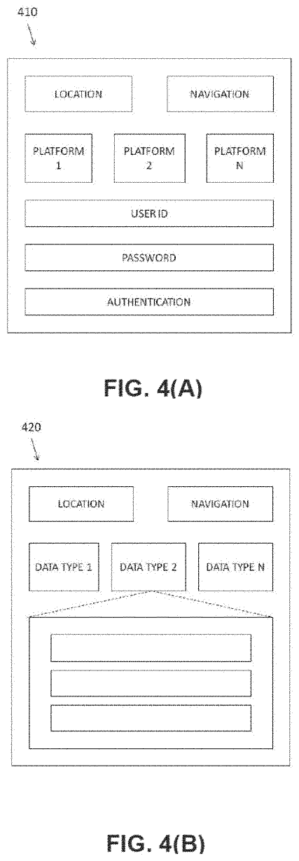

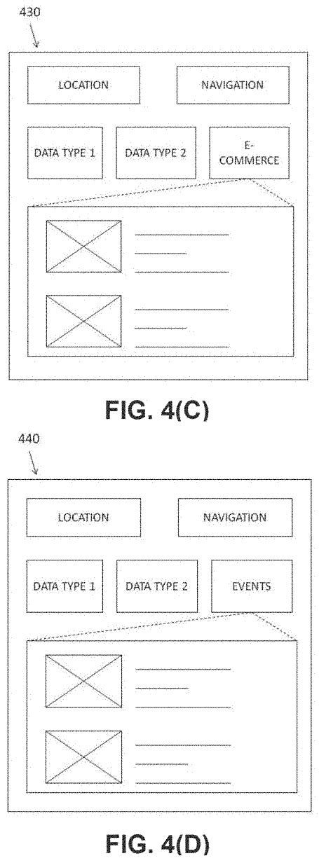

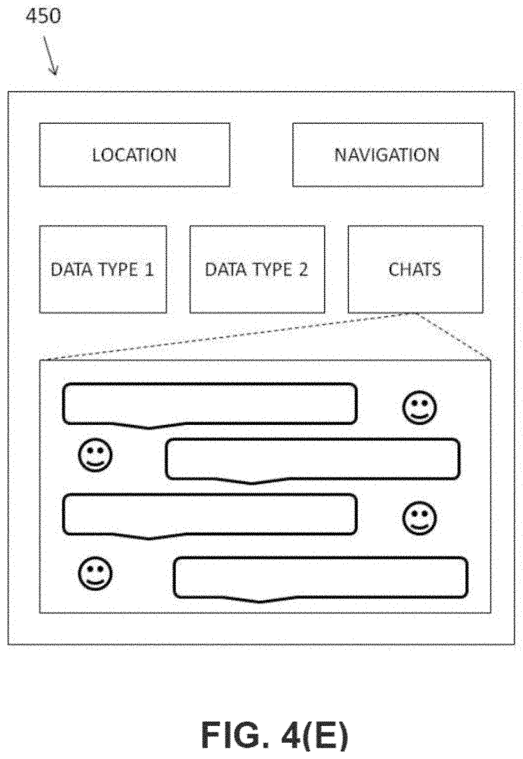

FIG. 4A illustrates an exemplary Single-Sign-On (SSO) facility 410 of the computing platform, according to an exemplary implementation of the present disclosure. In the present SSO facility 410 of the computing platform, the user may be connected with an application every time using one single/federated identity. This identity can either be user social identity or mobile number OTP. Further, by using the single sign-on facility, the users do not have to remember complex passwords nor the easily-remembered weak passwords. Hence, this helps in increasing both the user productivity and the application security.

FIG. 4B illustrates an exemplary aggregated data from plurality of sources on a single platform 420, according to an exemplary implementation of the present disclosure. This single platform acts as a one destination for all social media data where seamless access to mainstream social media network is provided to the user. Further, there is a multi-platform integration across the leading social media platforms that creates an aggregated wall for feeds from various platforms such as Facebook, Twitter, Instagram, YouTube and so on. Further, the single platform sources rich media content from various social media platforms providing with a seamless experience. The rich media offered in adaptive streaming aids in concurring the best possible content in a quick and easy manner.

FIG. 4C illustrates an exemplary implementation 430 of e-commerce facility integrated on the computing platform, according to an exemplary implementation of the present disclosure. In the present exemplary implementation, the other modules 126 further comprises a processing module which is configured to provide an e-commerce facility. The e-commerce platform is configured to provide the physical shopping experience with seamless payment gateway to the user. In such arrangements, the user may get the benefits of offer rewards and redeemable loyalty points on each purchase. Basically, in other words, it's a point based loyalty program where frequent visitors earn points which is a great way to reward visitor loyalty.

FIG. 4D illustrates an exemplary implementation 440 of event calendar facility integrated on the computing platform, according to an exemplary implementation of the present disclosure. In the present exemplary implementation, the processing module is configured to an event calendar wherein the user may download or sync the event with a device/system specific calendar. In the present event calendar facility, events may be created by anyone (Example—Followers/Influencers) and may be open to anyone or privately. The creator may invite his friends, members of the group, or fans/followers. The event is a calendar-based resource which may be used to notify the users of upcoming occasions. There is also a facility of creating an RSVP list, which displays list of invitees grouped by their response, and it further appears on their homepage to notify their mutual friends. Thus, it publicises the upcoming events or occasions with an ease.

FIG. 4E illustrates an exemplary implementation 450 of instant messaging service (chat) integrated on the computing platform, according to an exemplary implementation of the present disclosure. In the present exemplary implementation, the processing module is configured to a chat community wherein the chat section is a cross-platform instant messaging service for computing devices such as a smartphone that uses the internet for communication. In addition to text messaging, the end user or influencers may create groups, and invite others to join the group, user may send each other graphical stickers, emoticons, images, videos, audios, files, voice messages, contacts and user locations. Moreover, the users can share specific post from a social media platform across their friends or a particular group.

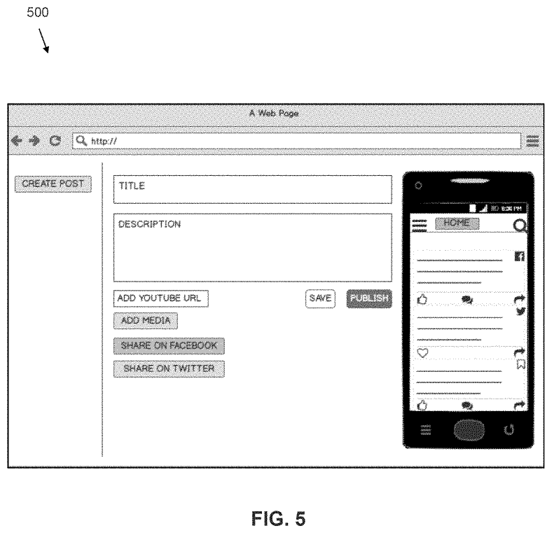

FIG. 5 illustrates an exemplary implementation 500 of reverse posting of the content on the computing platform, according to an exemplary implementation of the present disclosure. In the present implementation, the reverse posting feature provides one main destination for all social media platforms. For example, an influencer may post tool designate content across the social media platform which may raise the reverse engagement. Hence, there is an exponential reach to followers and non-followers with the reverse social media integration.

The system further provides personalized user experience to the fans/followers wherein personalized wishes can be sent to the fan following with audio/video content. It further provides sharing and creating user generated content with their fans/followers. The system further provides fan favoritism that allows sharing content with celebrity or within the community. The community will allow fans to create their own profiles, publish pictures, videos and create polls. Further, there is a fan community which makes it possible to build micro communities of fans with similar interests. They can explore other profiles and even exchange virtual gifts. There is also a facility of fan-chats wherein those with maximum followers/influencers can launch and moderate their own chats with fans creating more engagement.

Further, one can view fan data with specific demography with capability to send fan specific invitations or promotional messages. One can then deliver campaigns targeting fans with based on behavioural pattern coming out of analytics. Moreover, the celebrity can give away rewards for content consumption by the fans. The platform further works with the advertisers and it connects them with the right audiences using highly targeted prime time video advertisements. Additionally, the platform aids the end users as well as the advertisers in several ways. The end users earn unlimited money or rewards in various ways such as by installing various applications, by conducting surveys, by inviting other users and so on. Further, the end users may spend the earned money or the reward in various ways such as mobile prepaid recharges, DTH recharges, post-paid bill payment, gift vouchers and so on. Further, the end users may invite friends to download the application and on doing so the user may earn money. In case of the advertisers, they may view ability assurance, target the audience, campaign analytics and so on.

Further, the user such as celebrity may also post their exclusive choice of audio and video content, anytime and anywhere. Further, the system also provides collation of news content regarding the celebrity from major news sites. Thus, the news articles from several digital news channels are grouped together by topic and also by similar headlines. Additionally, the system provides a live streaming feature that allows the engagement of celebrity and their fans. Thus, the system provides a single platform wherein all the information is available which avoids the need to download varied social media applications by the user.

The foregoing description of the invention has been set merely to illustrate the invention and is not intended to be limiting. Since modifications of the disclosed embodiments incorporating the spirit and substance of the invention may occur to person skilled in the art, the invention should be construed to include everything within the scope of the disclosure.

1. A method for providing a plurality of data from a plurality of sources in a computing environment having a memory and a processor, the method comprising:
authenticating one or more users to provide an access to a computing platform;
scheduling one or more jobs on a web server to fetch the plurality of data from the plurality of sources;
polling said web server for fetching said plurality of data;
aggregating the fetched plurality of data based on one or more user defined rules;
storing the aggregated data to a content repository;
analysing the aggregated data based on said user defined rules;
storing the analysed data in a database;
streaming the data based on one or more request received from the web server;
rendering said one or more requested data to said users.

2. The method as claimed in claim 1, further comprises authenticating said users using a single sign-on facility, wherein the user is connected to the computing platform by a social identity.

3. The method as claimed in claim 1, further comprises authenticating said users using the single sign-on facility, wherein the user is connected to the computing platform by a one-time password.

4. The method as claimed in claim 1, wherein said one or more jobs comprises fetching an incremental data based on the characteristics of the last fetched data.

5. The method as claimed in claim 1, wherein analysing includes classifying the aggregated data based on timestamp information, data type and other user defined parameters.

6. A system for providing a plurality of data from a plurality of sources in a computing environment, the system comprising:
a memory;
a processor coupled with the memory;
an authentication module couple with the processor, the authentication module configured to:
authenticate one or more users to provide an access to a computing platform;
an aggregator module coupled with the processor, the aggregator module configured to:
schedule one or more jobs on a web server to fetch the plurality of data from the plurality of sources;
poll said web server to fetch said plurality of data;
aggregate the fetched plurality of data based on one or more user defined rules;
a storage module coupled with the processor, the storage module configured to store the aggregated data to a content repository;
a classification module coupled with the processor, the classification module configured to:
analyse the aggregated data based on said user defined rules and storing the analysed data in a database;
stream the data based on the request received from the web server;
a display module coupled with the processor, the display module configured to:
render said one or more requested data to said users.

7. The system as claimed in claim 6, wherein the authentication module is further configured to:
authenticate said users using a single sign-on facility wherein the user is connected to the computing platform by a social identity.

8. The system as claimed in claim 6, wherein the authentication module is further configured to:
authenticate said users using the single sign-on facility wherein the user is connected to the computing platform by a one-time password.

9. The system as claimed in claim 6, wherein the aggregator module is further configured to schedule said one or more jobs to fetch an incremental data based on the characteristics of the last fetched data.

10. The system as claimed in claim 6, wherein the classification module is further configured to classify the aggregated data based on timestamp information, data type and other user defined parameters.

11. The system as claimed in claim 6, further comprises a personalized news feed configured to the aggregator module to aggregate information regarding a specific user which is accessible to one or more users.

12. The system as claimed in claim 6, further comprises a personal social media access wherein said one or more users may have a customized user experience.

13. The system as claimed in claim 6, wherein the aggregator module is further configured to provide a reverse social media integration platform wherein a post by said specific user on a single computing platform is accessible to said one or more users on plurality of platforms.

14. The system as claimed in claim 6, further comprises a processing module, wherein the processing module coupled with the processor and configured to:
provide an e-commerce facility for promotion of activities by the users;
provide a chat community for interaction of said users within the chat community, and
provide an event calendar to schedule upcoming events.
